(19) United States
(12) Patent Application Publication
(10) Pub. No.: US 2013/0259409 A1
(43) Pub. Date: Oct. 3, 2013

(54) LINEAR SLIDING BLOCK

(71) Applicant: Kuo-Le Tsao, New Taipei City (TW)

(72) Inventor: Kuo-Le Tsao, New Taipei City (TW)

(21) Appl. No.: 13/431,958

(22) Filed: Mar. 27, 2012

(51) Int. Cl. F16C 33/66

(52) U.S. Cl. 384/13

(57) ABSTRACT

A linear sliding block includes a base block including a body member, which defines therein multiple load-bearing tracks, and a cover member, which defines two end block portions at two ends of the body member, non-load tracks, first oil passages respectively disposed in the load-bearing tracks and second oil passages located on the end block portions in communication with the first oil passages, two circulation-guiding blocks each defining a track skeleton and a complete semicircular circulation track connected to the load-bearing tracks and the non-load tracks, and rolling balls rolling in the load-bearing tracks, non-load tracks and complete semicircular circulation tracks to lubricate the linear sliding rail that carries the linear sliding block.

### BACKGROUND OF THE INVENTION

(a) Field of the Invention

The present invention relates to linear guideway technology and more particularly to a linear sliding block for carrying and moving a movable object along a linear sliding rail.

(b) Description of the Prior Art

A linear sliding block of a linear guideway is known to comprise a base block, two circulation-guiding blocks, and a plurality of rolling balls. The base block comprises a sliding groove fitting a linear sliding rail, a plurality of load-bearing tracks symmetrically disposed at two opposite lateral sides of the sliding groove, and a plurality of non-load tracks extending through the opposing front and rear ends thereof. The circulation-guiding blocks are respectively mounted at the opposing front and rear ends of the base block in such a manner that the load-bearing tracks and the non-load tracks form a close loop. The rolling balls are arranged in a line in the close loop. To avoid friction of the rolling balls, oil grooves are formed in the circulation-guiding blocks to accommodate a lubricating oil. When the rolling balls move through the circulation-guiding blocks, they will be lubricated by the lubricating oil.

The rolling balls can be lubricated only when they move through the oil grooves of the circulation-guiding blocks, i.e., the rolling balls are not additionally lubricated when rolling in the load-bearing tracks. Therefore, the rolling balls may not be sufficiently lubricated during the operation of the linear guideway. Further, this conventional design has no means to expel chips. During the sliding motion of the linear sliding block on the linear sliding rail in the work place, environmental dust, chips and other external objects may permeate into the gaps among the rolling balls in the linear sliding block, resulting in frictional damage of the rolling balls and the load-bearing tracks, or vibration or jamming of the linear sliding block.

A secondary injection molding technique may be employed to form dust strips on the circulation-guiding blocks for protection against dust and other external objects. However, the formation of the dust strips on the circulation-guiding blocks requires a high-precision mold and strict molding condition control, complicating the fabrication of the linear sliding block and increasing its manufacturing cost.

### SUMMARY OF THE INVENTION

The present invention has been accomplished under the circumstances in view. The present invention provides a linear sliding block for mounting on a linear sliding rail, which comprises a plurality of first oil passages respectively disposed in respective load-bearing tracks at two opposite lateral sides of a body member of a base block thereof, and second oil passages located on end block portions of a cover member of the base block in communication with the first oil passages for carrying a lubricating oil for lubricating a mating linear sliding rail by rolling balls to prevent wear of the rolling balls.

In addition, the present invention provides a linear sliding block, which comprises two circulation-guiding blocks arranged at the opposing front and rear ends of the base block and specially designed to eliminate concentration of stress, and two stop flanges respectively extending from the circulation-guiding blocks and fitting the linear sliding rail to prevent external objects from entering the linear sliding block and to enhance the level of stability of the sliding motion of the linear sliding block on the linear sliding rail.

### BRIEF DESCRIPTION OF THE DRAWINGS

FIG. 1 is an exploded view of a linear sliding block and a linear sliding rail constructed according to the present invention.

FIG. 2 is an exploded view of the linear sliding block in accordance with the present invention.

FIG. 3 is an oblique elevation of the body member of the linear sliding block in accordance with the present invention.

FIG. 4 is a schematic end view of the body member of the linear sliding block in accordance with the present invention.

FIG. 5 is an oblique elevation of the body member of the linear sliding block in accordance with the present invention.

FIG. 6 is a cutaway view of the base block of the linear sliding block in accordance with the present invention.

FIG. 7 is a sectional elevation of the base block of the linear sliding block in accordance with the present invention.

FIG. 8 is a schematic drawing of the present invention, illustrating the mounting pegs of the base block respectively affixed to the mounting holes of the circulation-guiding blocks (I).

FIG. 9 is a schematic drawing of the present invention, illustrating the mounting pegs of the base block respectively affixed to the mounting holes of the circulation-guiding blocks (II).

FIG. 10 is an exploded view of one circulation-guiding block of the linear sliding block in accordance with the present invention.

FIG. 11 corresponds to FIG. 10 when viewed from another angle.

FIG. 12 is an exploded view of the outer block member of one circulation-guiding block of the linear sliding block in accordance with the present invention.

FIG. 13 corresponds to FIG. 12 when viewed from another angle.

FIG. 14 is a schematic drawing illustrating an operation status of the linear sliding block on the linear sliding rail in accordance with the present invention.

### DETAILED DESCRIPTION OF THE PREFERRED EMBODIMENTS

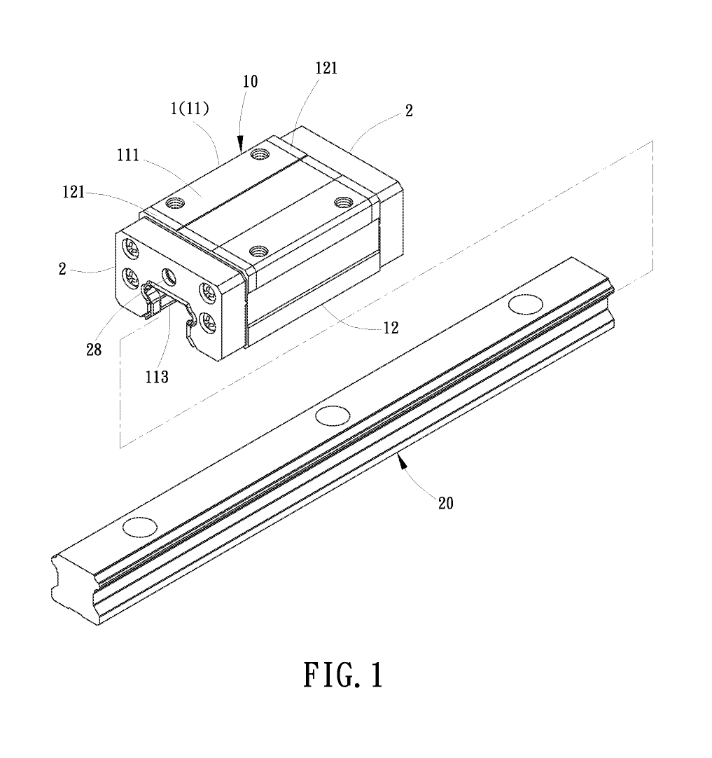

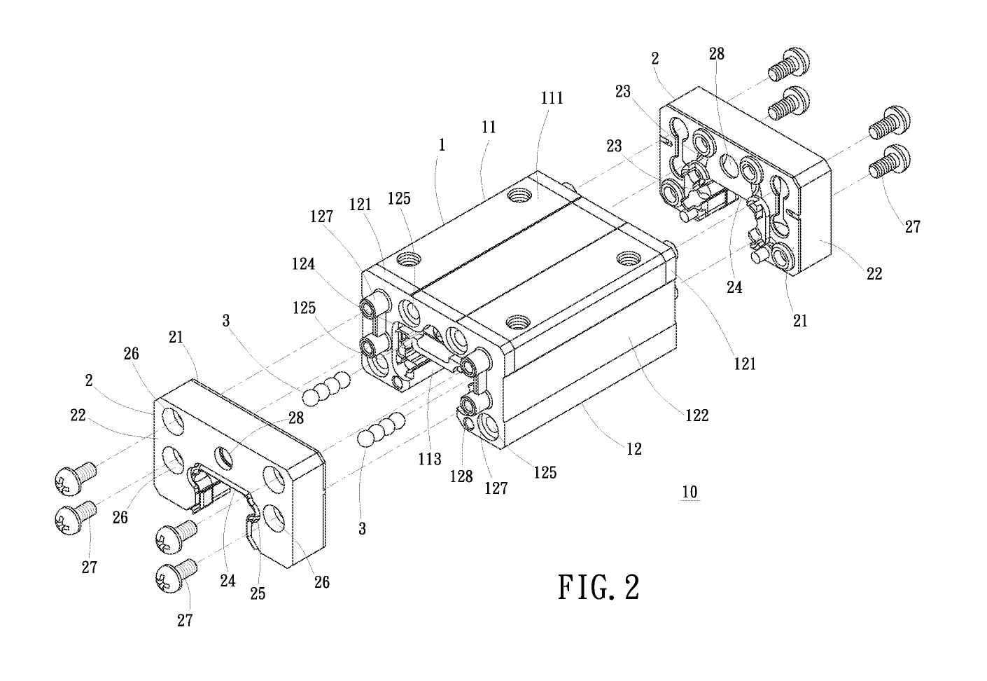

As shown in FIGS. 1 and 2, a linear sliding block 10 in accordance with the present invention is mounted on a linear sliding rail 20 to constitute a linear guideway. The linear sliding block 10 comprises a base block 1, two circulation-guiding blocks 2 and a plurality of rolling balls 33.

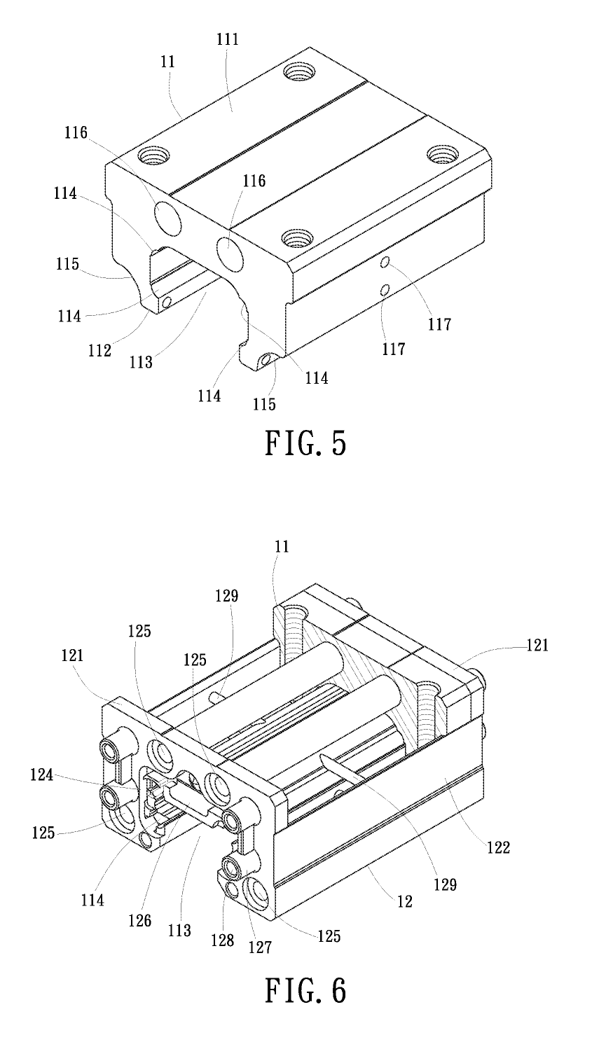

Referring to FIGS. 3-5 and FIG. 2 again, the base block 1 comprises a body member 11, and a cover member 12 integrally formed with and covered on a part of the body member 11. As shown in FIG. 5, the body member 11 comprises a top wall 111 exposed outside the cover member 12, a bottom wall 112 disposed opposite to the top wall 111, a sliding groove 113 located on the bottom wall 112 and extending through the opposing front and rear ends of the body member 11, and a plurality of load-bearing tracks 114 bilaterally and symmetrically formed in the sliding groove 113 at two opposite lateral sides and extending through the opposing front and rear ends of the body member 11.

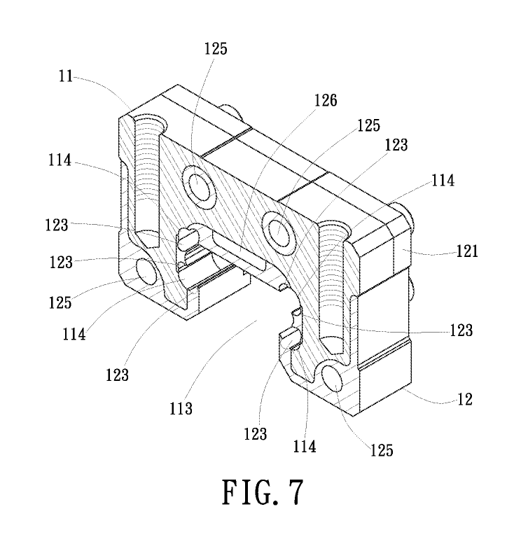

Referring to FIGS. 6 and 7 and FIG. 4 again, the cover member 12 is made of plastics or a suitable moldable material and molded on the body member 11, comprising two end block portions 121 respectively covered on the opposing front and rear ends of the body member 11, a plurality of connection portions 122 bilaterally connected between the end block portions 121, a plurality of first oil passages 123 respectively disposed in the load-bearing tracks 114, and a plurality of second oil passages 124 respectively located on the end block portions 121 and facing toward the respective circulation-guiding blocks 2. Further, the opposing ends of the first oil passages 123 respectively extend through the end block portions 121 in communication with the second oil passages 124. Thus, the lubricating oil filled into the second oil passages 124 can flow into the first oil passages 123.

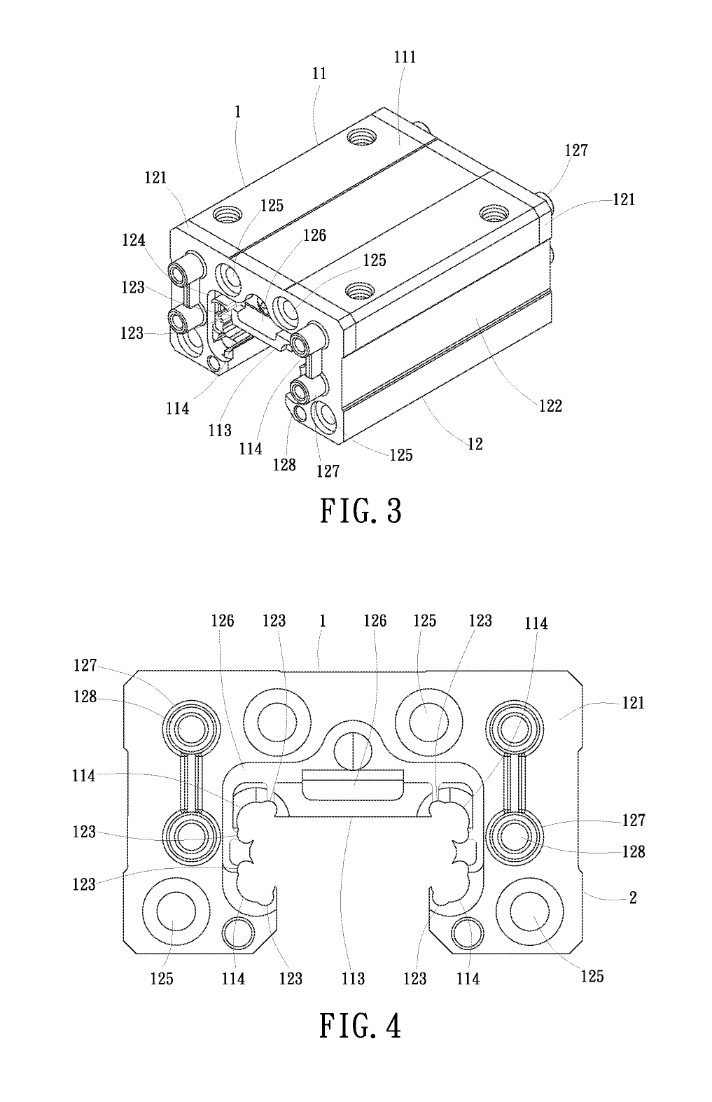

Referring to FIGS. 3, 4 and 6 again, the cover member 12 further comprises a plurality of non-load tracks 125 connected between the two end block portions 121. Thus, the non-load tracks 125 are kept in communication with the load-bearing tracks 114 through the circulation-guiding blocks 2. Preferably, grooves 115 are respectively formed on the two opposite lateral sides of the body member 11, and the non-load tracks 125 are respectively formed in the grooves 115 in the form of a through hole.

Alternatively, through holes 116 can be formed in the body member 11, and the non-load tracks 125 can be selectively formed in the through holes 116. After the rolling balls 3 are mounted in the load-bearing tracks 114 and the non-load tracks 125, the rolling balls 3 can circulate in the load-bearing tracks 114 and the non-load tracks 125 through the circulation-guiding blocks 2.

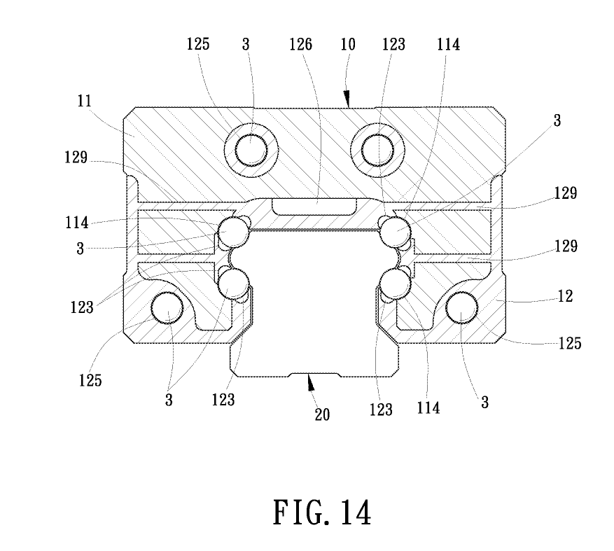

Referring to FIG. 14 and FIG. 6 again, insertion holes 117 can be formed in the two opposite lateral sides of the body member 11 in communication with the sliding groove 113. After the cover member 12 is molded on the body member 11, anchor pegs 129 are formed in the insertion holes 117 to enhance the bonding tightness between the body member 11 and the cover member 12.

Referring to FIGS. 8 and 9 and FIG. 1 again, the two circulation-guiding blocks 2 are respectively mounted at the opposing front and rear ends of the base block 1 to keep the load-bearing tracks 114 of the base block 1 in communication with the non-load tracks 125.

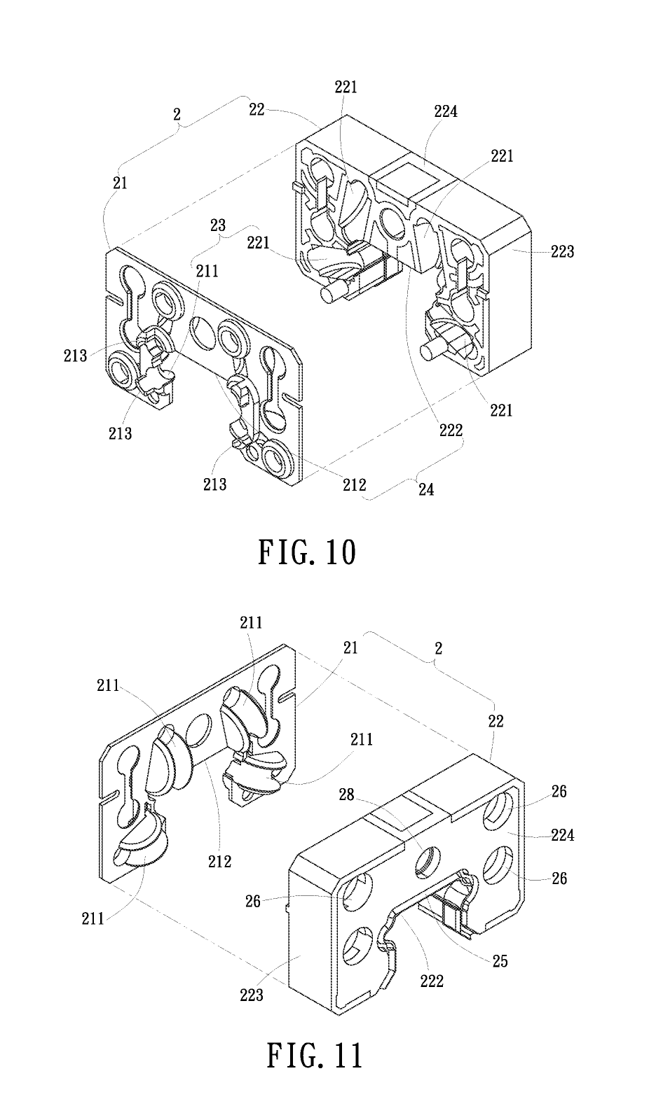

Referring to FIGS. 10 and 11 and FIGS. 1, 8 and 9 again, each circulation-guiding block 2 comprises an inner block member 21 and an outer block member 22. The inner block member 21 comprises a circulation groove first half segment 211, which is formed on the outer side of the inner block member 21 that faces toward the outer block member 22 and has the two distal ends thereof connected to the opposing inner side of the inner block member 21, a plurality of connection lugs 213, which respectively protrude from the inner side of the inner block member 21 around the two distal ends of the circulation groove first half segment 211, and a first rim 212 disposed corresponding to one side of the linear sliding rail 20. The outer block member 22 comprises a circulation groove second half segment 221 mating the circulation groove first half segment 211, and a second rim 222 fitting the same side of the linear sliding rail 20. When the inner block member 21 and the outer block member 22 are assembled together, the circulation groove first half segment 211 of the inner block member 21 and the circulation groove second half segment 221 of the outer block member 22 are matched together, forming a complete semicircular circulation track 23 that is connected to the load-bearing tracks 114 and the non-load tracks 125 by the connection lugs 213 that guide the rolling balls 3 to circulate through the semicircular circulation track 23, the load-bearing tracks 114 and the non-load tracks 125. Thus, the rolling balls 3 can move smoothly during the circulation without noises due to component gaps. Further, the first rim 212 of the inner block member 21 and the second rim 222 of the outer block member 22 are joined together, forming a track skeleton 24 that matches the linear sliding rail 20.

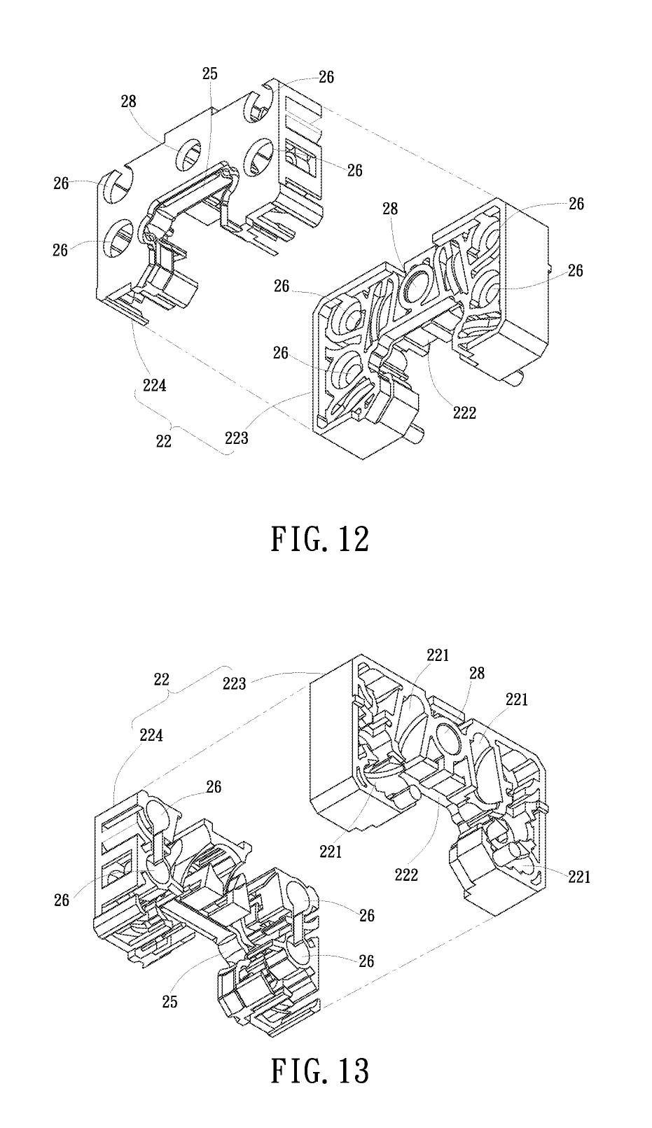

Further, as shown in FIG. 12 and FIG. 13, the outer block member 22 is formed of a rigid plastic component 223 and a soft plastic component 224 using a dual injection molding technique, i.e., the rigid plastic component 223 is injection-molded first, and then the soft plastic component 224 secondarily injection-molded on the rigid plastic component 223. Further, during the molding process to form the soft plastic component 224 on the rigid plastic component 223, a stop flange 25 is formed around the second rim 222 for stopping against the linear sliding rail 20. The stop flange 25 is disposed corresponding to the flexible frame strip of the linear sliding rail 20.

Referring to FIG. 14 and FIG. 2 again, the rolling balls 3 are accommodated in the load-bearing tracks 114 and the non-load tracks 125 of the base block 1 and the semicircular circulation tracks 23 of the circulation-guiding blocks 2. When rolling into the load-bearing tracks 114, the rolling balls 3 are abutted against the first oil passages 123 to touch on the lubricating oil flowing in the first oil passages 123 and to apply the lubricating oil so received to the linear sliding rail 20 for enabling the linear sliding block 10 to move along the linear sliding rail 20 smoothly.

Referring to FIGS. 3 and 4 again, the cover member 12 further comprises at least one third oil passage 126 disposed in communication with the second oil passages 124 in the end block portions 121. Thus, the lubricating oil can flow through the at least one third oil passage 126 between the second oil passages 124 into the two end block portions 121.

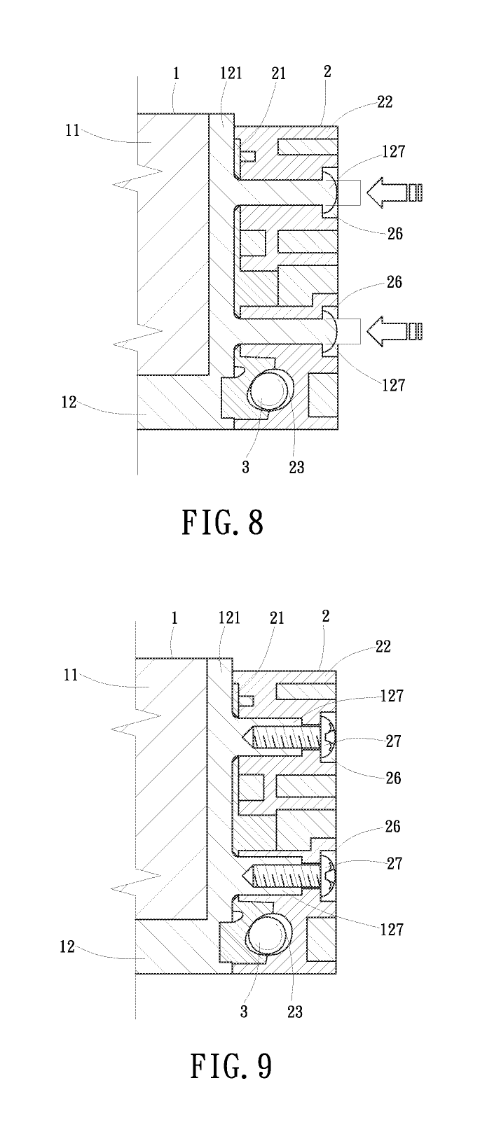

Referring to FIG. 8, the cover member 12 of the base block 1 comprises a plurality of mounting pegs 127 respectively fastened to the circulation-guiding blocks 2. Each of the two circulation-guiding blocks 2 comprises a plurality of mounting holes 26 for receiving the mounting pegs 127 of the base block 1. By means of thermal compression techniques, the mounting pegs 127 of the base block 1 can be respectively affixed to the mounting holes 26 of the circulation-guiding blocks 2 (see the arrowhead sign in FIG. 8) to tightly secure the circulation-guiding blocks 2 to the opposing front and rear ends of the base block 1. Further, as shown in FIG. 2 and FIG. 9, each mounting peg 127 defines therein a fastening hole, for example, screw hole 128; fastening members, for example, tie screws 27 are respectively mounted in the mounting holes 26 of the circulation-guiding blocks 2 and threaded into the screw hole 128 of the mounting pegs 127 to affix the circulation-guiding blocks 2 to the base block 1.

Referring to FIG. 2 again, each circulation-guiding block 2 further comprises an oil-filling hole 28 disposed in communication with the second oil passages 124, facilitating filling of the prepared lubricating oil into the second oil passages 124 and the first oil passages 123. Further, the rigid plastic component 223 of the outer block member 22 is injection-molded to provide a plurality of equally spaced ribs and a plurality of bonding grooves defined between each two adjacent ribs for the bonding of the soft plastic component 224. The ribbed structure of the rigid plastic component 223 enables the stress produced during the injection molding process to mold the soft plastic component 224 on the rigid plastic component 223 to be evenly distributed.

By means of molding technology, the first oil passages 123 and the second oil passages 124 can be directly formed in the cover member 12 of the linear sliding block, thus simplifying the manufacturing process and reducing the manufacturing cost. Further, through the first oil passages 123 and the second oil passages 124, the applied lubricating oil can flow into the load-bearing tracks 114 through which the rolling balls 3 are rolling in a line, achieving optima lubrication. Further, the first oil passages 123 also provide a chip escape function for enabling external objects that fall accidentally into the load-bearing tracks 114 to be transferred by the rolling balls 3 into the first oil passages 123. Further, by employing dual injection molding techniques to make the rigid plastic component 223 having a ribbed structure and to form the soft plastic component 224 on the rigid plastic component 223, the invention effectively eliminates molding stress during the fabrication of the circulation-guiding blocks 2. Further, a stop flange 25 is formed around the second rim 222 during the secondary molding process to mold the outer block member 22 of each circulation-guiding block 2. After the linear sliding block 10 is installed in the linear sliding rail 20, the stop flanges 25 of the circulation-guiding blocks 2 are kept in close contact with the linear sliding rail 20, protecting the linear sliding block 10 against external objects.

Although a particular embodiment of the invention has been described in detail for purposes of illustration, various modifications and enhancements may be made without departing from the spirit and scope of the invention. Accordingly, the invention is not to be limited except as by the appended claims.

1. A linear sliding block for mounting on a linear sliding rail to constitute a linear guideway, the linear sliding block comprising:
a base block comprising a body member and a cover member integrally formed with and covered on a part of said body member, said body member comprising a top wall exposed outside said cover member, a bottom wall disposed opposite to said top wall, a sliding groove located on said bottom wall and extending through opposing front and rear ends of said body member, and a plurality of load-bearing tracks bilaterally and symmetrically formed in two opposite lateral surfaces of said sliding groove and extending through the opposing front and rear ends of said body member, said cover member comprising two end block portions respectively covered on the opposing front and rear ends of said body member, a plurality of connection portions bilaterally connected between said two end block portions, a plurality of non-load tracks connected between said two end block portions, a plurality of first oil passages respectively disposed in said load-bearing tracks, and a plurality of second oil passages respectively located on said end block portions, said first oil passages each having opposing ends thereof respectively extended through said end block portions in communication with said second oil passages;
two circulation-guiding blocks respectively mounted at opposing front and rear ends of said base block to keep said load-bearing tracks in communication with said non-load tracks, each said circulation-guiding block comprising an inner block member and an outer block member, said inner block member comprising a circulation groove half segment facing toward the associated outer block member, and a rim disposed corresponding to one side of said linear sliding rail, said outer block member comprising a circulation groove half segment and a rim fitting said linear sliding rail, said circulation groove half segment of said inner block member and said circulation groove half segment of said outer block member being matched together to form a complete semicircular circulation track, said rim of said inner block member and said rim of said outer block member being joined together to form a track skeleton matching said linear sliding rail, said outer block member further comprising a first plastic component and a second plastic component molded on said first plastic component, said second plastic component comprising a stop flange disposed around said rim of said outer block member for stopping against said linear sliding rail; and
a plurality of rolling balls accommodated in said load-bearing tracks and the circulation tracks of said circulation-guiding blocks and abutting against said first oil passages in said load-bearing tracks and rotatable along said linear sliding rail,
wherein said cover member further comprises a plurality of integrally formed mounting pegs, said two circulation-guiding blocks each comprise a plurality of mounting holes for receiving said mounting pegs of said cover member, and each of the mounting pegs defines therein a fastening hole for a screw to fasten the associated circulation-guiding block to said cover member.

2. The linear sliding block as claimed in claim 1, wherein said non-load tracks have respective opposing ends respectively kept in communication with said circulation tracks of said circulation-guiding blocks.

3. The linear sliding block as claimed in claim 2, wherein said body member comprises a plurality of grooves respectively formed on two opposite lateral sides thereof; said non-load tracks are respectively formed in the grooves of said body member in the form of a through hole.

4. The linear sliding block as claimed in claim 2, wherein said body member comprises a plurality of through holes; said non-load tracks are formed in the through holes of said body member.

5. The linear sliding block as claimed in claim 1, wherein said body member comprises a plurality of insertion holes located on two opposite lateral sides of the body member; said cover member comprises a plurality of anchor pegs respectively fastened to said insertion holes of said body member.

6. The linear sliding block as claimed in claim 1, wherein said cover member further comprises at least one third oil passage disposed in communication with said second oil passages of said end block portions.

7. (canceled)

8. (canceled)

9. (canceled)

10. The linear sliding block as claimed in claim 1, wherein said two circulation-guiding blocks each comprise an oil filling hole disposed in communication with said second oil passages.

11. The linear sliding block as claimed in claim 1, wherein said inner block member comprises a plurality of connection lugs respectively protruding from an inner side thereof opposite to the circulation groove half segment of said inner block member and connected to the complete semicircular circulation track of the respective circulation-guiding block.
